(19) United States
(12) Patent Application Publication
(10) Pub. No.: US 2023/0169417 A1
(43) Pub. Date: Jun. 1, 2023

(54) Systems and Methods for Using a Semi-Fungible Digital Asset in a Supply Chain Ecosystem

(71) Applicant: Verizon Patent and Licensing Inc., Basking Ridge, NJ (US)

(72) Inventors: Dante J. Pacella, Charles Town, WV (US); Nazneen Khan, Alpharetta, GA (US)

(21) Appl. No.: 17/538,602

(22) Filed: Nov. 30, 2021

(51) Int. Cl. G06Q 10/06; G06Q 10/08

(52) U.S. Cl. CPC G06Q 10/0631; G06Q 10/087

(57) ABSTRACT

An exemplary method includes a resource distribution system that assigns a semi-fungible digital asset to a plurality of resources, sets a value of a resource counter of the semi-fungible digital asset based on a number of resources in the plurality of resources, detects a distribution event associated with the plurality of resources, and adjusts the value of the resource counter based on the distribution event.

### BACKGROUND INFORMATION

Advances in digital asset management have resulted in different types of digital assets that may be used by users of computer systems. For example, a digital asset may be leveraged to facilitate tracking distribution of a resource through a supply chain network. Information associated with the distribution of the resource through the supply chain network may be recorded in a distributed ledger (e.g., a blockchain).

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary resource distribution system according to principles described herein.

FIG. 2 illustrates an exemplary configuration of a semi-fungible digital asset that may be implemented according to principles described herein.

FIG. 3 illustrates an exemplary implementation of the resource distribution system of FIG. 1 according to principles described herein.

FIG. 4 illustrates an exemplary flow chart depicting various operations that may be performed according to principles described herein.

FIG. 5 illustrates an exemplary distribution event that may be implemented with respect to a semi-fungible digital asset according to principles described herein.

FIG. 6 illustrates an exemplary implementation in which a semi-fungible digital asset may be leveraged to facilitate distribution of a pharmaceutical according to principles described herein.

FIGS. 7-8 illustrate exemplary flow charts showing various operations that may be performed in a supply chain ecosystem according to principles described herein.

FIGS. 9-11 illustrate exemplary methods for using a semi-fungible digital asset in a supply chain ecosystem according to principles described herein.

FIG. 12 illustrates an exemplary computing device according to principles described herein.

### DETAILED DESCRIPTION OF PREFERRED EMBODIMENTS

Systems and methods for using a semi-fungible digital asset in a supply chain ecosystem are described herein. In certain examples, for instance, an exemplary method may include assigning, by a resource distribution system, a semi-fungible digital asset to a plurality of resources. The semi-fungible digital asset may include a resource counter. The method may further include setting, by the resource distribution system, a value of the resource counter based on a number of resources in the plurality of resources. The method may further include detecting, by the resource distribution system, a distribution event associated with the plurality of resources. The method may further include adjusting, by the resource distribution system, the value of the resource counter based on the distribution event.

As used herein, a “semi-fungible digital asset” may refer to any suitable type of digital asset (e.g., a semi-fungible token (“SFT”)) that may be configured to be both fungible and non-fungible during its lifecycle and that may be used to track resources. Semi-fungible digital assets such as those described herein may define or otherwise include one or more operating parameters. Such operating parameters of a semi-fungible digital asset may specify any suitable information associated with when and/or where a semi-fungible digital asset may be used, who may access information associated with the semi-fungible digital, when an authorized entity may access information associated with the semi-fungible digital asset, an amount of or how many resources are currently associated with the semi-fungible digital asset, and/or any other suitable parameters. Semi-fungible digital assets such as those described herein may each be unique but may include fungible components. For example, a semi-fungible digital asset may include a resource counter as a parameter that may be considered as a fungible component of the semi-fungible digital asset. While the resource counter has a value greater than zero, the semi-fungible digital asset may be considered as having fungible characteristics. However, when the resource counter has a value of zero, the semi-fungible digital asset may be considered as having non-fungible characteristics. Exemplary semi-fungible digital assets will be described further herein.

Various advantages and benefits are associated with the systems and methods for using a semi-fungible digital asset in a supply chain ecosystem described herein. For example, systems and methods such as those described herein provide a secure and efficient way of tracking/managing end-to-end distribution, custody, and/or use (e.g., consumption) of resources throughout a supply chain ecosystem (e.g., from manufacturer to an end user). In addition, by using a semi-fungible digital asset that includes a resource counter, end-to-end resource inventory controls may be implemented throughout the supply chain ecosystem. For example, semi-fungible digital assets such as those described herein may be used as a flow control mechanism such that, once a resource consumption/resource counter threshold is crossed, flow of a resource is increased, decreased, started/stopped, etc. Further, semi-fungible digital assets such as those described herein may be used to govern or transition between different rates, classes of services/queues, or invoke back off scaling mechanisms/orchestrations. Moreover, systems and methods such as those described herein may facilitate obtaining information during distribution and/or use of resources that may be used to optimize distribution processes, track usage of resources, and/or provide a secure flow of records. These and other benefits that may be provided by systems and methods described herein will be evident from the disclosure that follows.

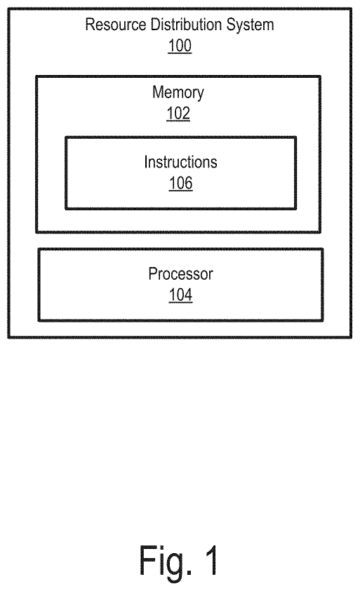

FIG. 1 illustrates an exemplary resource distribution system 100 (“system 100”). As shown, system 100 may include, without limitation, a memory 102 and a processor 104 selectively and communicatively coupled to one another. Memory 102 and processor 104 may each include or be implemented by hardware and/or software components (e.g., processors, memories, communication interfaces, instructions stored in memory for execution by the processors, etc.). In some examples, memory 102 and/or processor 104 may be implemented by any suitable computing device. In other examples, memory 102 and/or processor 104 may be distributed between multiple devices and/or multiple locations as may serve a particular implementation. Illustrative implementations of system 100 is described herein.

Memory 102 may maintain (e.g., store) executable data used by processor 104 to perform any of the operations described herein. For example, memory 102 may store instructions 106 that may be executed by processor 104 to perform any of the operations described herein. Instructions 106 may be implemented by any suitable application, software, code, and/or other executable data instance.

Memory 102 may also maintain any data received, generated, managed, used, and/or transmitted by processor 104. Memory 102 may store any other suitable data as may serve a particular implementation. For example, memory 102 may store data representative of semi-fungible digital assets, analytical information associated with distribution and/or use of semi-fungible digital assets, and/or any other suitable data.

Processor 104 may be configured to perform (e.g., execute instructions 106 stored in memory 102 to perform) various processing operations associated with distribution of resources through a supply chain ecosystem. For example, processor 104 may perform one or more operations described herein to use a semi-fungible digital asset to track and/or facilitate distribution of resources through the supply chain ecosystem, including setting and adjusting a value of a resource counter of a semi-fungible digital asset based on distribution events. These and other operations that may be performed by processor 104 are described herein.

System 100 (e.g., processor 104) may be configured to provide any suitable service and/or feature that may be associated with semi-fungible digital assets as may serve a particular implementation. For example, system 100 may be configured to generate digital assets (e.g., semi-fungible digital assets, non-fungible digital assets, etc.), manage access to information associated with digital assets, facilitate sharing of digital assets, facilitate use of resources associated with digital assets, and/or provide any other suitable service and/or feature that may facilitate using digital assets in a supply chain ecosystem.

As used herein, a “supply chain ecosystem” may refer to a network of entities that may be associated with manufacture, distribution, and/or use of resources such as those described herein. A supply chain ecosystem may include any suitable type of distribution channel as may serve a particular implementation. For example, in certain implementations, a supply chain ecosystem may include a digital distribution channel through which digital resources may be digitally distributed to end users. Alternatively, a supply chain ecosystem may include a physical distribution channel through which physical resources may be physically shipped to end users. Alternatively, a supply chain ecosystem may include a combination of a digital distribution channel and physical distribution channel.

Semi-fungible digital assets such as those described herein may be implemented in a supply chain ecosystem in any suitable manner. For example, semi-fungible digital assets such as those described herein may be included in a bill of lading, a bill of materials, may be used for recall tracing, tax and tariff, and/or granular cost allocation through the supply chain ecosystem, through subsidiaries, through multiple business units and/or cost centers, etc.

The use of semi-fungible digital assets in a supply chain ecosystem may provide any suitable data associated with resources. For example, such data may provide country of origin of a resource, eco-friendly status of a resource, and/or carbon data associated with a resource to end users for any suitable purpose (e.g., to support fair trade initiatives, buy local initiatives, buy organic initiatives, anti-blood diamond initiatives, etc.).

In certain examples, system 100 may be configured to generate semi-fungible digital assets. This may be accomplished in any suitable manner. For example, system 100 may provide any suitable user interface to facilitate a user selecting parameters to be used to generate semi-fungible digital assets. Any suitable protocol (e.g., a blockchain protocol) may be used to facilitate generating a semi-fungible digital asset as may serve a particular implementation. For example, system 100 may use an Ethereum-based SFT standard such as ERC-1155 with added functions such as those described herein to facilitate generating semi-fungible digital assets.

In certain implementations, semi-fungible digital assets such as those described herein may be implemented by or incorporated in smart contracts that are configured to facilitate tracking distribution and/or use of resources in a supply chain ecosystem. Such a smart contract may be configured to automatically execute one or more operations based on satisfaction of a predefined condition. As used herein, the expression “automatically” means that an operation (e.g., a recording operation in a distributed record) or series of operations are performed without requiring further input from a user. For example, a detected use of a resource may trigger automatic execution of the smart contract including automatically accessing a distributed record and automatically updating of a value of a resource counter of a semi-fungible digital asset based on the detected use.

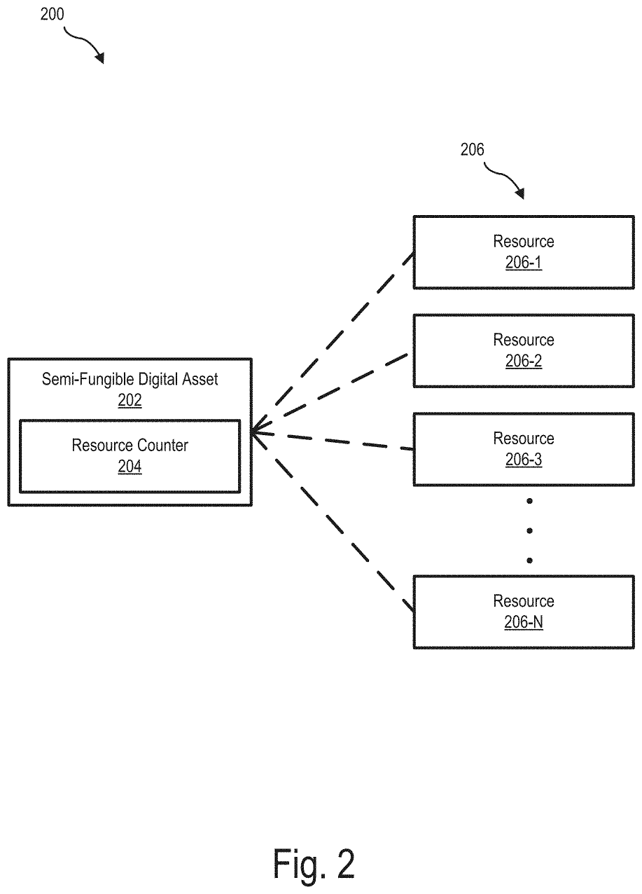

FIG. 2 illustrates an exemplary implementation 200 of a semi-fungible digital asset 202 that may be provided in certain implementations. As shown in FIG. 2, semi-fungible digital asset 202 includes a resource counter 204 that may be used to monitor a plurality of resources 206 (e.g., resources 206-1 through 206-N) associated with semi-fungible digital asset 202. Resource counter 204 may have any suitable value as may serve a particular implementation. In certain examples, resource counter 204 may have a value that is based on a number of resources included in plurality of resources 206 associated with semi-fungible digital asset 202. System 100 may adjust the value of the resource counter in any suitable manner. For example, system 100 may increase, decrease, refund, replenish, or perform any other suitable operation to adjust the value of the resource counter. To illustrate an example, the value of resource counter 204 may initially equal “N” based on “N” number of resources being associated with semi-fungible digital asset 202. As resources included in plurality resources 206 are distributed or used (e.g., consumed), system 100 may adjust the value of the resource counter. For example, if resource 206-1 is used during distribution of plurality of resources 206, system 100 may change the value of resource counter 204 from “N” to “N−1.” In certain examples, resource counter 204 may have a value that is based on an amount of a particular resource included in plurality of resources 206.

Plurality of resources 206 may include any suitable resource that may be associated with semi-fungible digital asset 202. In certain examples, plurality of resources 206 may correspond to digital resources that may be distributed by way of any suitable digital content distribution network, such as described herein. For example, plurality of resources 206 may include access authorization to access digital content and/or services. In certain alternative implementations, plurality of resources 206 may correspond to physically consumable resources that may be distributed by way of a physical distribution network and physically consumed by one or more users. For example, plurality of resources 206 may include a pharmaceutical that may be distributed to and physically consumed (e.g., through ingestion) by an end user in certain implementations.

In certain examples, resources included in plurality of resources 206 may be multi-dimensional. For example, a resource may correspond to a content delivery network (“CDN”) that may have multiple dimensions in the form of storage, sessions, data transfer, etc. and may be further differentiated for caching hierarchy (e.g., origin, shield cache, edge cache, mobile edge computing, etc.), session types (e.g., new, concurrent, web forms, CTAs, advertisement insertions/tracking, dynamic events, etc.), and/or data transfer (e.g., small object, large object, peer-to-peer/BitTorrent/IPFS offload, long-lived streams, etc.). Semi-fungible digital asset 202 may be used to track usage of such resources across each dimension and adjust one or more resource counters to either limit the service for that dimension or change the charging/pricing tier dependent on multi-dimensional models associated with such resources.

In certain examples, resources included in plurality of resources 206 may be fungible with respect to each other. That is, each of resources 206-1 through 206-N may be interchangeable and may be traded like-for-like with each other. For example, in implementations where plurality of resources 206 are pharmaceuticals, each resource included in plurality of resources 206 may correspond to an instance of the same pharmaceutical (e.g., the same pill).

FIG. 2 shows only one resource counter 204 being included as part of semi-fungible digital asset 202. However, it is understood that in certain examples semi-fungible digital asset 202 may include multiple resource counters. Any suitable number of resource counters may be used as may serve a particular implementation. In certain examples, each resource counter may be configured to track a different type or set of resources that may be associated with semi-fungible digital asset 202. For example, semi-fungible digital asset 202 may include a first resource counter that has a value that is based on a number of resources in a first plurality of resources, a second resource counter that has a value that is based on a number of resources included in a second plurality of resources, a third resource counter that has a value that is based on a number of resources in a third plurality of resources, and a fourth resource counter having a value that is based on an amount of a particular resource. The first plurality of resources, the second plurality of resources, the third plurality of resources, and the fourth plurality of resources may be different from each other.

To illustrate an example, semi-fungible digital asset 202 may be configured to track usage of multiple different resources associated with a video conference call. For example, semi-fungible digital asset 202 may include a first resource counter that has a value based on an amount of bandwidth available during the video conference call, a second resource counter having a value based on the number of available spots to participate in the video conference call, and a third resource counter having a value based on the number of available break out rooms. In such an example, system 100 may be configured to monitor the bandwidth, the available spots, and the available break out rooms during the course of the video conference call and adjust the value of each of the first, second, and third resource counters accordingly.

In certain examples, the multiple resource counters may have a cumulative effect such that if the value of any of them goes below a predefined threshold (e.g., if the value of any one of them goes to zero), they all may be considered as having gone below the predefined threshold. To illustrate, in the example described above, the available bandwidth going to zero in a video conference call may result in all of the resource counters being considered as having gone to zero. In such an example, any of the resource counters going below the predefined threshold may trigger a predefined operation. For example, a relatively higher service tier associated with providing the video conference call may be triggered in response to any of the resource counters going below the predefined threshold.

In certain alternative implementations, multiple semi-fungible digital assets may be linked together or otherwise associated in any suitable manner to facilitate tracking usage of multiple different resources. For example, instead of a single semi-fungible digital asset (e.g., semi-fungible digital asset 202) being used in the example described above, a first semi-fungible digital asset may be provided that includes a first resource counter that has a value based on an amount of bandwidth available during the video conference call, a second semi-fungible digital asset may be provided that includes a second resource counter having a value based on the number of available spots to participate in the video conference call, and a third semi-fungible digital asset may be provided that includes a third resource counter having a value based on the number of available break out rooms.

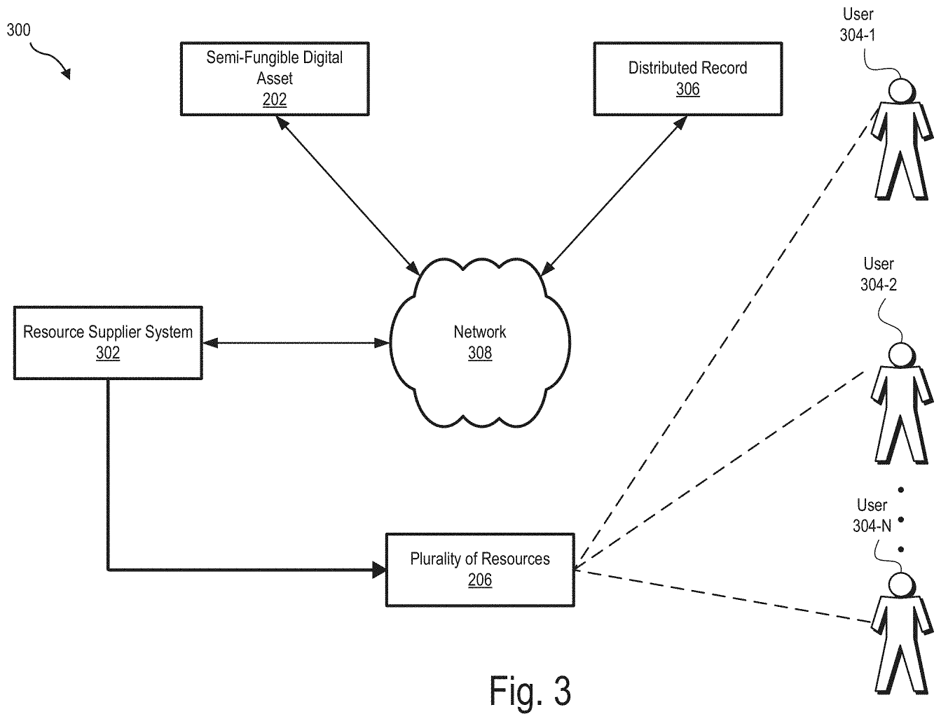

System 100 may be implemented in any suitable manner as may serve a particular implementation. FIG. 3 shows an exemplary implementation 300 in which system 100 may be provided in certain examples. As shown in FIG. 3, implementation 300 includes a resource supplier system 302 that is configured to distribute plurality of resources 206 to users 304 (e.g., users 304-1 through 304-N). As shown in FIG. 3, resource supplier system 302 is configured to communicate with a distributed record 306 by way of a network 308. Resource supplier system 302 may be implemented by any suitable computing device or combination of computing devices as may serve a particular implementation. For example, resource supplier system 302 may be implemented by desktop computers, laptop computers, smartphones, and/or any other suitable type of computing device(s). System 100 may be implemented by resource supplier system 302. Alternatively, system 100 may be distributed across resource supplier system 302 and/or any other suitable computer system.

Distributed record 306 may correspond to any suitable type of distributed record as may serve a particular implementation that may be configured to track distribution of plurality of resources 206. For example, distributed record 306 may correspond to a distributed ledger that is implemented using blockchain technology in certain examples. Although distributed record 306 is shown as being separate from resource supplier system 302, it is understood that a copy of distributed record 306 may be stored in any suitable storage device associated with resource supplier system 302 and/or any other suitable computer system. Alternatively, distributed record 306 may be distributed across resource supplier system 302 and any other suitable computer system.

Resource supplier system 302 may interface with distributed record 306 using any communication platforms and technologies suitable for transporting data and/or communication signals, including known communication technologies, devices, media, and protocols supportive of remote communications, examples of which include, but are not limited to, data transmission media, communications devices, and data transmission protocols.

Network 308 may include, but is not limited to, one or more wireless networks (Wi-Fi networks), wireless communication networks, mobile telephone networks (e.g., cellular telephone networks), mobile phone data networks, broadband networks, narrowband networks, the Internet, local area networks, wide area networks, live television transmission networks, and any other networks capable of carrying media content, data, and/or communications signals between resource supplier system 302 and any other system implementing distributed record 306. Communications between resource supplier system 302 and any other system implementing distributed record 306 may be transported using any one of the above-listed networks, or any combination or sub-combination of the above-listed networks. Alternatively, resource supplier system 302 and any other computer system implementing distributed record 306 may communicate in another way such as by one or more direct connections between resource supplier system 302 and any other system implementing distributed record 306.

Resource supplier system 302 may be owned or operated by an entity that provides resources 206 associated with semi-fungible digital asset 202. In certain examples, resource supplier system 302 may generate semi-fungible digital asset 202. Such an entity may use resource supplier system 302 (e.g., system 100) in any suitable manner to specify parameters used to form semi-fungible digital asset 202. Alternatively, resource supplier system 302 may obtain semi-fungible digital asset 202 from a third party.

As shown in FIG. 3, resource supplier system 302 may distribute plurality of resources 206 to users 304. Resource supplier system 302 may distribute plurality of resources 206 to users 304 in any suitable manner. For example, as shown in FIG. 3, resource supplier system 302 may distribute plurality of resources 206 to users 304 by way of a distribution channel other than through network 308 in certain examples. This may occur in examples where plurality of resources 206 include physical resources (e.g., physically consumable resources). In certain alternative implementations, plurality of resources may correspond to digital resources. In such examples, resource supplier system 302 may distribute plurality of resources 206 to users 304 by way of network 308. In such examples, each of users 304 may be associated with any suitable type of user computing device (not shown) that may be used to access plurality of resources 206 by way of network 308.

Semi-fungible digital asset 202 may be stored in any suitable manner and at any suitable location as may serve a particular implementation. In certain examples, semi-fungible digital asset 202 may be stored remotely from resource supplier system 302 and may be accessible by resource supplier system 302 by way of network 308. For example, semi-fungible digital asset 202 may be hosted at a server that is remote from resource supplier system 302. Resource supplier system 302, for example, may implement a digital wallet application that stores keys that are usable to access semi-fungible digital asset 202 wherever it is stored. For example, the keys may be used to access semi-fungible digital asset 202 at a network address associated with semi-fungible digital asset 202 and hosted by the server. Such a server may be implemented as part of resource supplier system 302 or may be a third-party server that is remote from resource supplier system 302. In certain alternative implementations, the keys stored by a digital wallet application may be used to access semi-fungible digital asset 202 from a local storage device of resource supplier system 302.

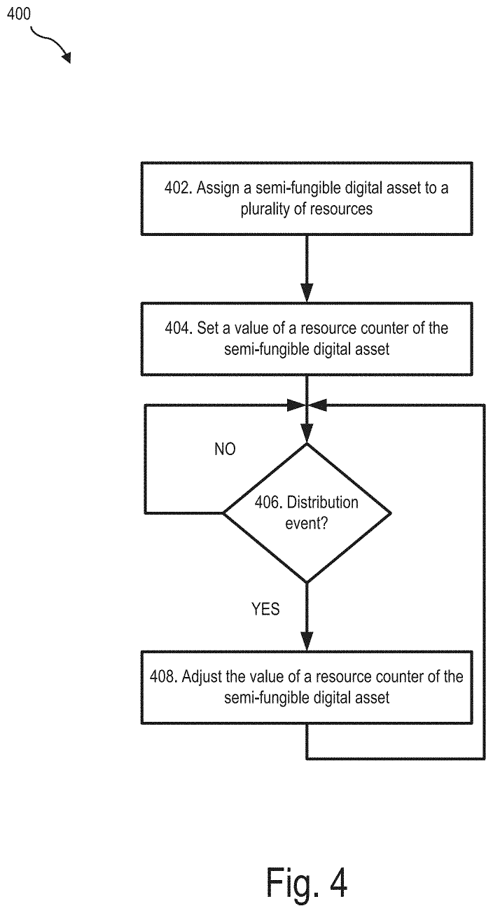

FIG. 4 depicts a flowchart 400 showing exemplary operations that may be performed by system 100 to facilitate using a semi-fungible digital asset to track distribution and/or use of a plurality of resources. At operation 402, system 100 may assign a semi-fungible digital asset (e.g., semi-fungible digital asset 202) to a plurality of resources (e.g., plurality of resources 206). This may be accomplished in any suitable manner. For example, system 100 may record any suitable information associated with the plurality of resources as part of the semi-fungible digital asset. In certain examples, such information may include information that identifies the plurality of resources, identifies distribution parameters/requirements associated with distribution the plurality of resources, a quick response (“QR”) code that may be used to facilitate distribution of the plurality of resources, and/or any other suitable information.

At operation 404, system 100 may set a value of a resource counter (e.g., resource counter 204) of the semi-fungible digital asset. As described herein, the value of the resource counter may be based on the number of resources included in the plurality of resources associated with the semi-fungible digital asset. For example, if there are ten resources currently associated with the semi-fungible digital asset, system 100 may set the value of the resource counter to equal ten.

At operation 406, system 100 may detect a distribution event associated with the plurality of resources. As used herein, a “distribution event” may refer to any event that may occur during distribution and/or use of a plurality of resources. For example, a distribution event may cause an amount of a resource or a number of available resources included in the plurality of resources to change. In certain examples, a distribution event may comprise a consumption of a resource included in the plurality of resources. For example, a resource may correspond to an access token that may be used to access a content streaming service. In such examples, a consumption of the resource may correspond to use of an access token to access a content streaming service. In certain alternative examples, a resource may correspond to a physically consumable resource such as a pharmaceutical. In such examples, such a consumption of the resource may correspond to a physical consumption of the physically consumable resource.

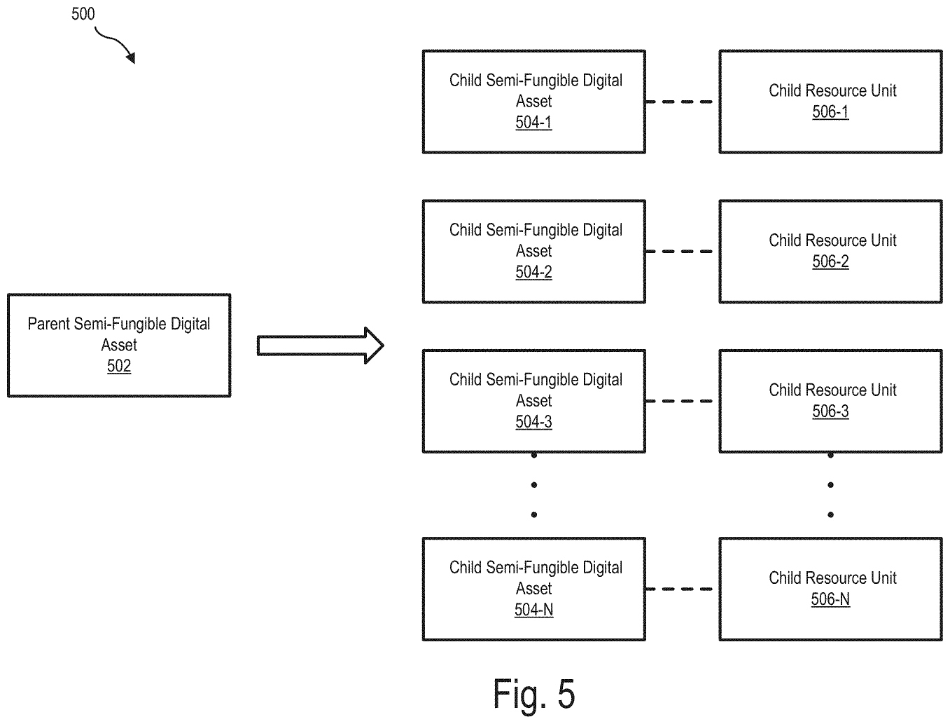

In certain examples, a distribution event may include separating resources out of the plurality of resources into a plurality of child resource units. To illustrate, FIG. 5 shows an exemplary implementation 500 that depicts a parent semi-fungible digital asset 502 that is associated with a plurality of child semi-fungible digital assets 504 (e.g., child semi-fungible digital assets 504-1 through 504-N). Each child semi-fungible digital asset 504 may be linked back to and draw resources from parent semi-fungible digital asset 502. As shown in FIG. 5, each child semi-fungible digital asset 504 is associated respectively with a child resource unit 506 (e.g., child resource units 506-1 through 506-N). Child resource units 506 represent a subset of the resources that were previously associated with parent semi-fungible digital asset 502. Each of child semi-fungible digital assets 504 may include a resource counter configured to track a number of resources that are included in child resource units 506 and that were drawn from parent semi-fungible digital asset 502. For example, child semi-fungible digital asset 504-1 may include a first resource counter configured to track a number of resources included in child resource unit 506-1, child semi-fungible digital asset 504-2 may include a second resource counter configured to track a number of resources included in child resource unit 506-2, child semi-fungible digital asset 504-3 may include a second resource counter configured to track a number of resources included in child resource unit 506-3, and so forth.

Although FIG. 5 only shows one level of separation from parent semi-fungible digital asset 502 to child semi-fungible digital assets 504, it is understood that any suitable number of levels of separation may occur as may serve a particular implementation. For example, child semi-fungible digital asset 504-1 may be separated into one or more additional child semi-fungible digital assets. Each of the one or more additional child semi-fungible digital assets may be linked to and draw resources from child semi-fungible digital asset 504-1. Such multiple levels of separation may be useful in back to birth and/or reverse supply chain (returns) implementations in which different levels of separation may provide, for example, component-level and/or raw material tracing. In reverse supply chain implementations, parent/child semi-fungible digital assets may facilitate ensuring authenticity of resources such as replacement components.

System 100 may detect the distribution event in any suitable manner. For example, system 100 may detect the distribution event based on sensor data obtained during distribution, based on a modification to information associated with the semi-fungible digital asset and stored in distributed record 306, based on user input, based on a scanned QR code, based on a call being made to a smart contract implemented by the semi-fungible digital asset and stored in distributed record 306, and/or based on any other information or occurrence.

Returning to FIG. 4, if the answer at operation 406 is “NO,” the flow may return to before operation 406, as shown in FIG. 4. Alternatively, if the answer at operation 406 is “YES,” system 100 may adjust the value of the resource counter of the semi-fungible digital asset at operation 408. For example, system 100 may decrement the value of the resource counter by one if the distribution event resulted in one less resource included in the plurality of resources being available. Alternatively, system 100 may decrement the value of the resource counter by more than one if the distribution event resulted in multiple resources being used/consumed. For example, in implementation 500 shown in FIG. 5, system 100 may decrease the value of the resource counter of parent semi-fungible digital asset 502 by more than one based on the separating of the resources associated with parent semi-fungible digital asset 502 into child resource units 506.

In certain examples, system 100 may record information associated with the adjustment of the value of the resource counter in a distributed record (e.g., distributed record 306). This may be accomplished in any suitable manner. For example, system 100 may access any suitable interface to facilitate recording the adjustment of the value of a resource counter.

Subsequent to operation 408, the flow may return to before operation 406. System 100 may then repeat operations 406 and 408 any suitable number of times as may serve a particular implementation. For example, system 100 may detect an additional distribution event (e.g., an additional consumption) associated with an additional resource included in the plurality of resources. Based on the additional distribution event, system 100 may further adjust the value of the resource counter of the semi-fungible digital asset.

In certain examples, once the resource counter has a value of zero, system 100 may record semi-fungible digital asset 202 in distributed record 306 as a non-fungible record that chronicles any suitable information associated with distribution of the plurality of resources. Such a non-fungible record may be used for any suitable purpose such as to optimize distribution and/or use of resources, audit distribution of resources, etc.

In certain examples, system 100 may implement a replenish function that replenishes resources associated with a semi-fungible digital asset after the value of a resource counter reaches zero. In such examples, system 100 may determine, after adjusting the value of the resource counter, that the value of the resource counter is zero. System 100 may then increase the value of a resource counter according to the replenish function to a value that is greater than zero. As an example, the resources associated with a semi-fungible digital asset may correspond to access authorizations to use a media content streaming service. A user may initially have five access authorizations available. As such, the initial value of the resource counter of the semi-fungible digital asset may be five. After the user shares the access authorizations with five users, the resource counter may be decreased from five to zero. System 100 may then increase the value of the resource counter to a value greater than zero to accommodate additional or alternative users being authorized to use the media content streaming service. In certain examples, system 100 may increase the value of the resource counter based on a request provided by the user. Alternatively, system 100 may automatically increase the value of the resource counter based on a predetermined condition (e.g., based on the value of a resource counter reaching zero).

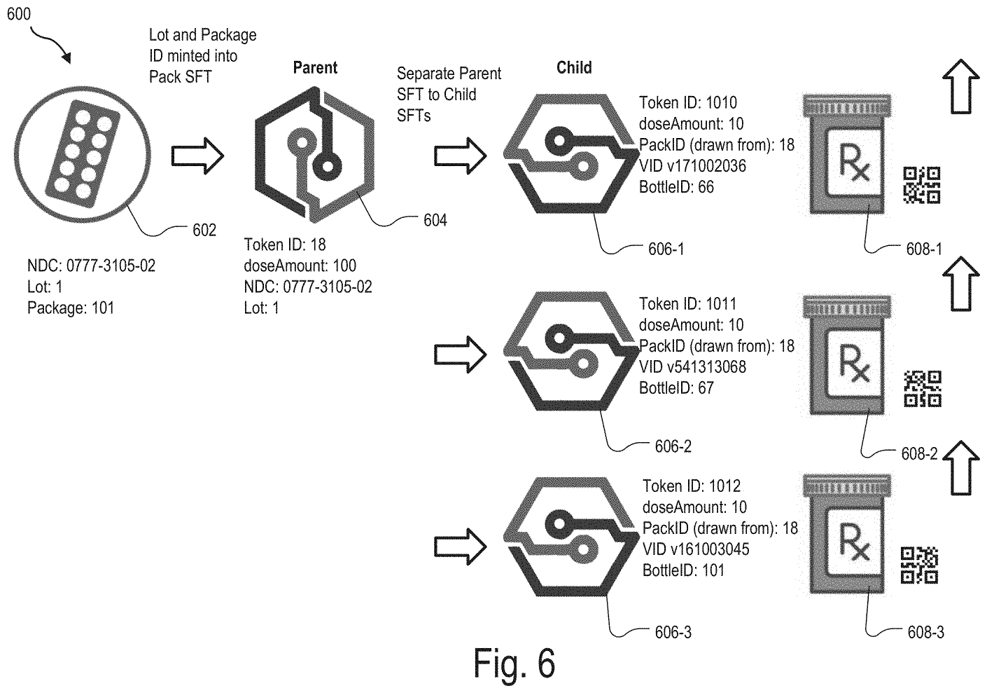

FIG. 6 illustrates an exemplary implementation 600 in which system 100 may be used to distribute a pharmaceutical. As shown in FIG. 6, pharmaceutical package 602 includes a pharmaceutical having a National Drug Code (“NDC”) of “0777-3105-02,” which identifies pharmaceutical package 602 as containing fluoxetine hydrochloride. Pharmaceutical package 602 is further identified as lot “1” and package “101.” System 100 may mint the NDC information, the lot information, and the package information associated with pharmaceutical package 602 to parent semi-fungible digital asset 604 (e.g., a parent SFT). Parent semi-fungible digital asset 604 may include any suitable information that may be used to identify the pharmaceutical. For example, such information may define a token ID as “18,” a dose amount as “100,” the NDC, and the lot as “1.” The dose amount specified by parent semi-fungible digital asset 604 may be representative of a resource counter of parent semi-fungible digital asset 604. Such information may additionally or alternatively include specifications of a container (e.g., a smart container) configured to store the pharmaceutical, a manufacturer ID that identifies the manufacturer of the pharmaceutical, the manufacture date of the pharmaceutical, the expiration date of the pharmaceutical, transport requirements for the pharmaceutical, a destination pharmacy ID, and/or any other suitable information.

As shown in FIG. 6, system 100 may separate parent semi-fungible digital asset 604 into a plurality of child semi-fungible digital assets 606 (e.g., child semi-fungible digital assets 606-1 through 606-3). Each child semi-fungible digital asset 606 may be linked to and draw from parent semi-fungible digital asset 604. In addition, each of child semi-fungible digital assets 606 includes information associated with the pharmaceutical included in respective containers 608 (e.g., containers 608-1 through 608-3). For example, child semi-fungible digital asset 606-1 includes information identifying at least a tokenID as “1010,” a dose amount as “10,” a packID as “18” indicating that child semi-fungible digital asset 606-1 is drawn from parent semi-fungible digital asset 604, an identifier as “VID,” and a bottle ID as “66.” The dose amount of “10” for child semi-fungible digital asset 606-1 indicates that container 608-1 includes 10 dosages of the pharmaceutical. As a result of the dose amount of 10 being added to child semi-fungible digital asset 606-1, system 100 adjusts the dose amount of parent semi-fungible digital asset 604 from 100 to 90. Similarly, system 100 adjusts the dose amount of parent semi-fungible digital asset 604 by ten for each of child semi-fungible digital assets 606-2 and 606-3 such that the remaining dose amount of parent semi-fungible digital asset 604 is 70 after child semi-fungible digital assets 606 are formed.

Containers 608 may be distributed in any suitable manner to one or more users of the pharmaceutical. As shown in FIG. 6, each of containers 608 may include a OR code to facilitate tracking usage of the pharmaceutical within containers 608. In certain examples, containers 608 may correspond to smart containers and may additionally or alternatively include any suitable sensor or combination of sensors configured to monitor when a dosage of the pharmaceutical has been taken by the user. In the example shown in FIG. 6, a user of container 608-1 may scan the QR code of container 608-1 in any suitable manner after taking a dose of the pharmaceutical. In response, system 100 may update the dose amount of child semi-fungible digital asset 606-1 from 10 to 9. In so doing, system 100 may be configured to efficiently track usage of the pharmaceutical by the user and generate information associated with the usage. Such information may include information regarding when the pharmaceuticals were consumed, how many of the pharmaceuticals were consumed, where the pharmaceuticals were consumed, whether any of the pharmaceuticals were not consumed. Such information may be used in any suitable manner, for example, to improve user compliance of treatment regimens, to facilitate disposal of unused pharmaceuticals, and/or for any other suitable purpose.

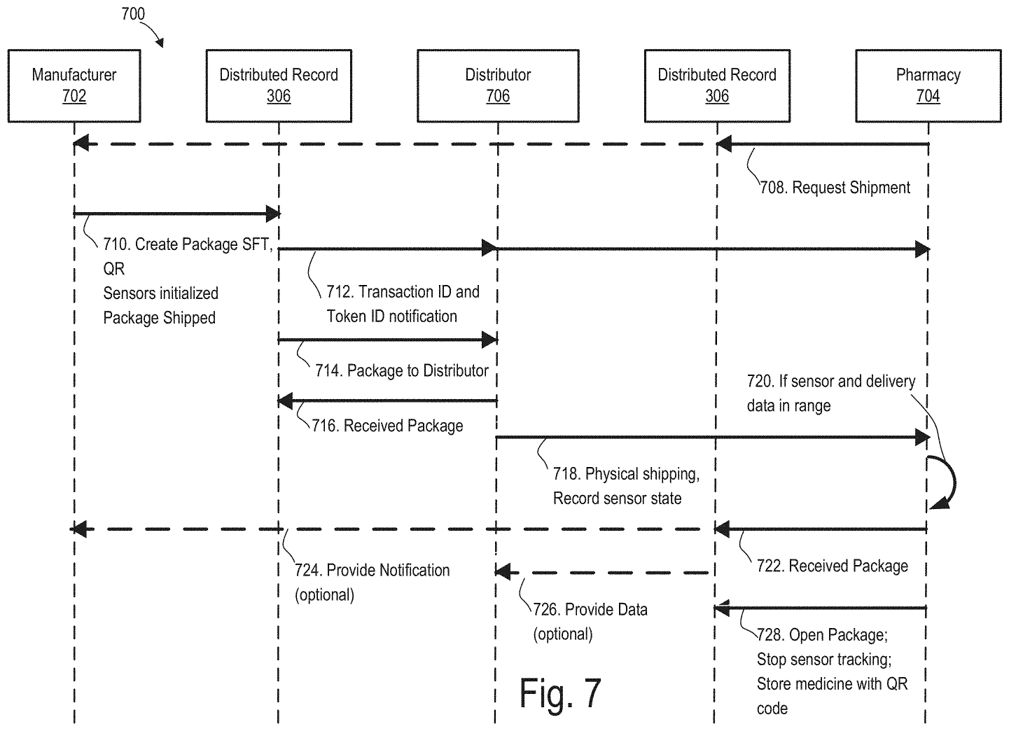

FIG. 7 illustrates an exemplary flow diagram 700 that depicts operations that may be implemented by system 100 during distribution of a pharmaceutical from a manufacturer 702 to a pharmacy 704 by way of a distributor 706. Although FIG. 7 only shows one distributor 706, it is understood that there may be one or more distributors provided in the supply chain ecosystem between manufacturer 702 and pharmacy 704. Alternatively, there may be no intermediate distributor between manufacturer 702 and pharmacy 704 in certain implementations.

As shown in FIG. 7, pharmacy 704 may provide a request to distributed record 306 and/or manufacturer 702 for a shipment of a pharmaceutical at operation 708. At operation 710, manufacturer 702 may perform various operations associated with the request. For example, manufacturer 702 may create a package SFT, generate a QR code, initialize sensors used to detect conditions during shipment, and ship the package of pharmaceuticals to distributor 706. Information associated with operation 710 may be stored in distributed record 306. At operation 712, distributed record 306 may generate and transmit a transaction ID and a token ID notification to distributor 706 and pharmacy 704. At operation 714, the package is received by distributor 706. At operation 716, information indicating receipt of the package by distributor 706 may be stored in distributed record 306. At operation 718, the package is physically shipped to pharmacy 704.

During shipment of the package from manufacturer 702 to distributor 706 and pharmacy 704 one or more sensors may be used to track and record conditions that may occur during shipment. Any suitable sensor or combination of sensors may be used as may serve a particular implementation. For example, such sensors may include, but are not limited to, a temperature sensor, a humidity sensor, a shock sensor, and/or any other suitable sensor. Operation 718 may further include system 100 using such sensors to record sensor data during the shipment.

At operation 720, system 100 may determine whether the sensor data and delivery data satisfy predefined requirements. If they do not, system 100 may identify the package as being unacceptable. If, on the other hand, the sensor data and delivery data satisfy the predefined requirements at operation 720, system 100 may record information in distributed record 306 at operation 722 indicating that the package has been acceptably received. In certain examples, system 100 may provide a notification to manufacturer 702 regarding receipt of the package at operation 724. Additionally or alternatively, in certain examples, system 100 may provide data to distributor regarding receipt of the package at operation 726. Such data may include any suitable data associated with the shipment of the package from distributor 706 to pharmacy 704. For example, such data may include sensor data associated with the shipment and/or any other suitable data. In certain examples, such data may be used to either increase or decrease a reputation score of distributor 706. At operation 728, various operations may be performed to process the received package. For example, pharmacy 704 may stop sensor tracking, open the package, and store the pharmaceutical with a QR code.

In certain examples, system 100 may leverage one or more non-fungible digital assets in addition to a semi-fungible digital asset to facilitate distribution of a plurality of resources in a supply chain ecosystem. As used herein, a “non-fungible digital asset” may include any digital asset that is not interchangeable in terms of value and/or content with other digital assets. For example, a non-fungible digital asset may include a digital token, a still image, a digital signature or identifier, a live photograph, an audio file, a video file, and/or any other suitable non-fungible digital asset or combination of non-fungible digital assets. Any suitable protocol (e.g., blockchain protocol) may be used to facilitate generating a non-fungible digital asset as may serve a particular implementation. For example, system 100 may use an Ethereum-based non-fungible token (“NFT”) standard such as ERC-721 to facilitate generating non-fungible digital assets.

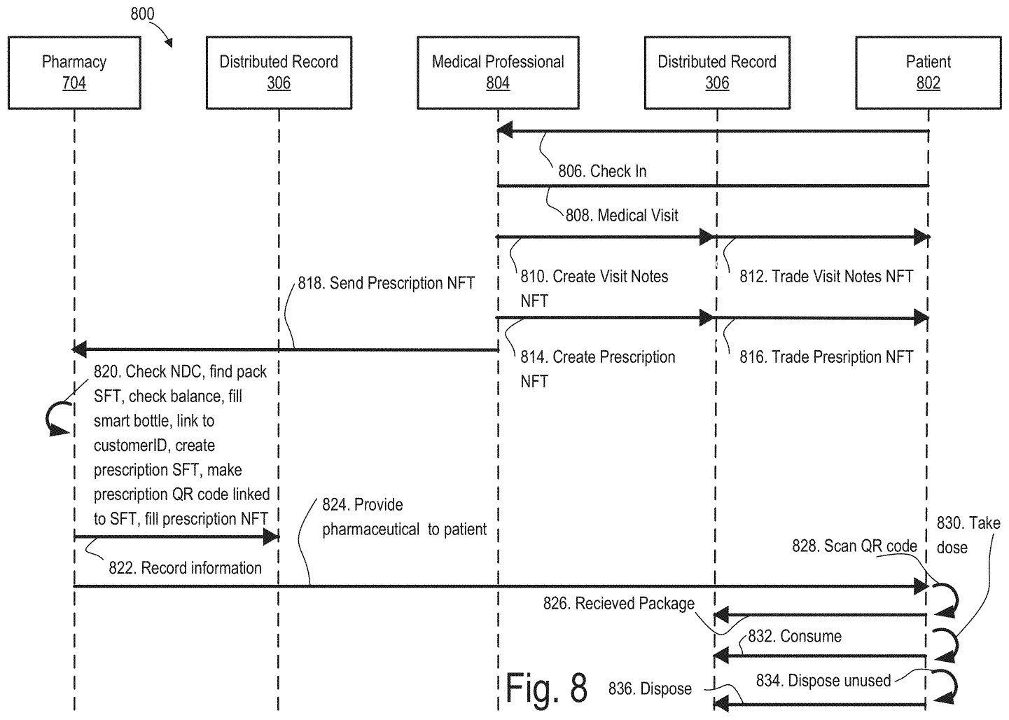

FIG. 8 illustrates an exemplary flow diagram 800 that depicts various operations that may be performed by system 100 during shipment of a pharmaceutical from pharmacy 704 to a patient 802. As shown in FIG. 8, patient 802 may check in with a medical professional 804 (e.g., a doctor) at operation 806. At operation 808, patient 802 may attend a medical visit with medical professional 804. Based on the medical visit, at operation 810 system 100 may generate a visit notes non-fungible digital asset that may be stored by distributed record 306.

At operation 812, system 100 may provide or otherwise make accessible the visit notes NFT to patient 802. At operation 814, system 100 may create a prescription NFT associated with the medical visit and store the prescription NFT in distributed record 306. At operation 816, system 100 may provide or otherwise make available the prescription NFT to patient 802. At operation 818, system 100 may send the prescription NFT to pharmacy 704 in any suitable manner.

At operation 820, pharmacy 704 (e.g., system 100) may perform various operations associated with filling the prescription represented by the prescription NFT. For example, system 100 may check the NDC associated with the prescription, find a package to fill the prescription, check the dose amount included in the package, fill a container with the prescribed pharmaceutical, link the prescribed pharmaceutical to a customer ID, create a prescription SFT, generate a prescription QR code linked to the prescription SFT, etc.

At operation 822, system 100 may record any suitable information associated with filling the prescription in distributed record 306. At operation 824, system 100 may provide the pharmaceutical to patient 802. At operation 826, information indicating that the package was received by patient 802 may be recorded in distributed record 306. At operation 828, patient 802 may scan the QR code associated with the pharmaceutical. At operation 830, patient 802 may take a dose of the pharmaceutical. At operation 832, information indicating that a dosage has been taken may be stored in distributed record 306. Such information may include an instruction by system 100 to reduce a value of a resource counter of the prescription SFT based on the consumption of the pharmaceutical. Operations 828 through 832 may be repeated any suitable number of times depending on the number of pharmaceuticals provided to patient 802. If any of the pharmaceutical is unused, the unused portion may be disposed in any suitable manner at operation 834. At operation 836, information associated with the disposed unused portion of the pharmaceutical may be recorded in distributed record 306.

In certain examples, system 100 may be configured to facilitate one or more entities accessing any suitable information regarding a semi-fungible digital asset and the associated resources as the resources move through a supply chain ecosystem. To that end, system 100 may implement an access authorization function that may be used to determine which entities are authorized to access information associated with a semi-fungible digital asset at any given time during distribution. In such examples, semi-fungible digital asset may be stored with ownership information in distributed record 306 that indicates which entities are authorized to access information associated with the semi-fungible digital asset. An entity (e.g., a pharmacy, a manufacturer, a patient, a distributor, a medical professional, etc.) wanting to access information associated with the semi-fungible digital asset during distribution may provide a signed message to system 100. Such a signed message may be configured in any suitable manner. In certain examples, the signed message may include an asset identifier of the semi-fungible digital asset and may include a nonce. The nonce may be used, for example, to prevent replay attacks from being used to fraudulently access the information associated with the semi-fungible digital asset. The nonce may correspond to any suitable arbitrary number that may be used in a cryptographic communication (e.g., for only one signed message).

System 100 may compare the signed message to ownership information stored in distributed record 306 and determine whether the entity is authorized to access the information associated with the semi-fungible digital asset. If system 100 determines that the entity is not authorized to access information associated with the semi-fungible digital asset, system 100 may deny access to the information. On the other hand, if system 100 determines that the entity is authorized, system 100 may facilitate the entity accessing the information in distributed record 306 in any suitable manner.

The exemplary implementations of semi-fungible digital assets described herein are provided for illustrative purposes only. It is understood that concepts such as those described herein may be used in any suitable additional or alternatively implementation as may serve a particular use case. For example, semi-fungible digital assets such as those described herein may be used in a supply chain ecosystem associated with high-end luxury consumables such as high-end alcoholic beverages (e.g., whiskey, wine, etc.). In such examples, a semi-fungible digital asset may be used in any suitable manner to ensure authenticity throughout a supply chain ecosystem from bottling to secondary sales and to consumption. In addition, the semi-fungible digital asset may facilitate capturing information associated with secondary sale revenue and/or tracking consumption. For example, a semi-fungible digital asset may be used in conjunction with an electronic device configured to register/record pours from a bottle. In such implementations, a connoisseur may be able to attest that they received a full pour and/or identify the provenance (even storage conditions) of a bottle.

In certain examples, a resource counter of a semi-fungible digital asset may be used to provide a weighted bias to a particular resource. For example, in cloud services, there may be different generations of machines/CPUs that may consume a CPU resource metric at different rates at the same interval. In such examples, weighting may be used to bias, for example, premium pricing for a new family of CPU that has limited quantities and/or favor usage of a new CPU that consumes significantly less energy or generates less heat (e.g., incentivizing desired usage). Such weighted bias of a resource counter may additionally or alternatively be based on a time of day, a day of the week, seasonal variance, and/or whether the resource at a given location is in peak or trough demand, etc. In certain additional or alternative implementations, a resource counter of a semi-fungible digital asset may be used to facilitate operations of a hardware security module (“HSM”) that, for example, safeguards and manages digital keys, performs encryption and decryption functions for digital signatures, strong authentication, and/or other cryptographic functions. In such examples, the HSM may implement a plurality of different resource counters. For example, a first resource counter may be used to track an amount of time used, a second resource counter may be used to track a number of transactions (e.g., above a predefined “free” threshold), and a third resource counter may be used to track a number of digital keys stored. A charge associated with the HSM may be calculated in any suitable manner based on the first, second, and third resource counters.

In certain additional or alternative implementations, a resource counter of a semi-fungible digital asset may be used to facilitate operations in a network I/O for cloud implementation. In such examples, the network I/O for cloud implementation may implement a plurality of different resource counters. For example, a first resource counter may be used to track direction (inbound/outbound), a second resource counter may be used to track a time of day/a day of week/a season, etc., a third resource counter may be used to identify a data center location (e.g., in which city data is being processed), a fourth resource counter may be used to track a source-destination pair (e.g., city pair, metro, intra-data center, intra-domain/VPC, etc.). The first through fourth resource counters may be used in any suitable manner to track usage of the network I/O cloud.

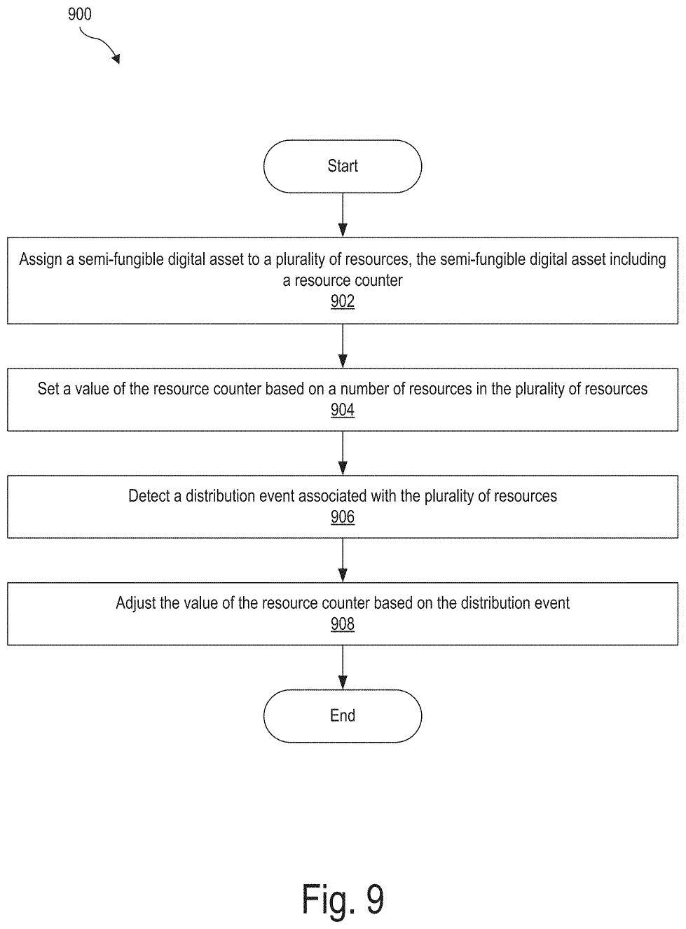

FIG. 9 illustrates an exemplary method 900 for using a semi-fungible digital asset in a supply chain ecosystem. While FIG. 9 illustrates exemplary operations according to one embodiment, other embodiments may add to and/or modify the operations shown in FIG. 9. The operations shown in FIG. 9 may be performed by system 100, any components included therein, and/or any implementation thereof.

At operation 902, a resource distribution system (e.g., resource distribution system 100) may assign a semi-fungible digital asset to a plurality of resources. As described herein, the semi-fungible digital asset may include a resource counter. Operation 902 may be performed in any of the ways described herein.

At operation 904, the resource distribution system may set a value of the resource counter based on a number of resources in the plurality of resources. Operation 904 may be performed in any of the ways described herein.

At operation 906, the resource distribution system may detect a distribution event associated with the plurality of resources. Operation 906 may be performed in any of the ways described herein.

At operation 908, the resource distribution system may adjust the value of the resource counter based on the distribution event. Operation 908 may be performed in any of the ways described herein.

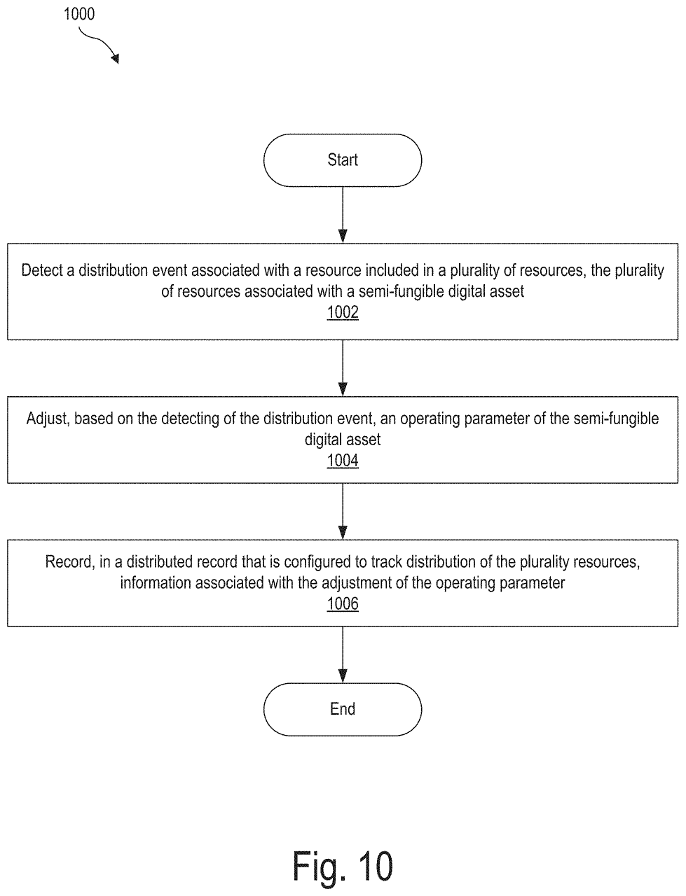

FIG. 10 illustrates another exemplary method 1000 for using a semi-fungible digital asset in a supply chain ecosystem. While FIG. 10 illustrates exemplary operations according to one embodiment, other embodiments may add to and/or modify the operations shown in FIG. 10. The operations shown in FIG. 10 may be performed by system 100, any components included therein, and/or any implementation thereof.

At operation 1002, a resource distribution system (e.g., resource distribution system 100) may detect a distribution event associated with a resource included in a plurality of resources. The plurality of resources may be associated with a semi-fungible digital asset that may define or otherwise include one or more operating parameters such as those described herein. For example, in certain implementations, the semi-fungible digital asset may define a resource counter that identifies a number of resources in the plurality of resources. Operation 1002 may be performed in any of the ways described herein.

At operation 1004, the resource distribution system may adjust, based on the detecting of the distribution event, an operating parameter of the semi-fungible digital asset. For example, the resource distribution system may adjust a value of a resource counter defined by the semi-fungible digital asset in certain implementations. Operation 1004 may be performed in any of the ways described herein.

At operation 1006, the resource distribution system may record, in a distributed record that is configured to track distribution of the plurality of resources, information associated with the adjustment of the operating parameter. For example, the resource distribution system may record information associated with the adjusted value of the resource counter in the distributed record. Operation 1006 may be performed in any of the ways described herein.

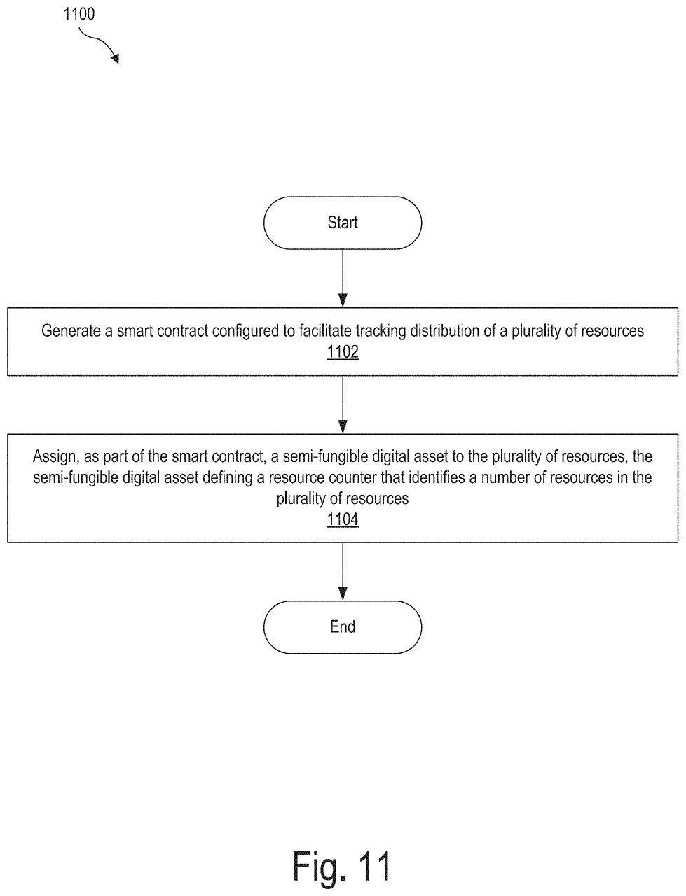

FIG. 11 illustrates another exemplary method 1100 for using a semi-fungible digital asset in a supply chain ecosystem. While FIG. 11 illustrates exemplary operations according to one embodiment, other embodiments may add to and/or modify the operations shown in FIG. 11. The operations shown in FIG. 11 may be performed by system 100, any components included therein, and/or any implementation thereof.

At operation 1102, a resource distribution system (e.g., resource distribution system 100) may generate a smart contract configured to facilitate tracking distribution of a plurality of resources. Operation 1102 may be performed in any of the ways described herein.

At operation 1104, the resource distribution system may assign, as part of the smart contract, a semi-fungible digital asset to the plurality of resources. The semi-fungible digital asset may define a resource counter that identifies a number of resources in the plurality of resources. Operation 1104 may be performed in any of the ways described herein.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory (RAM), and an optical disc (e.g., a compact disc, a digital video disc, a Blu-ray disc, etc.). Exemplary volatile storage media include, but are not limited to, RAM (e.g., dynamic RAM).

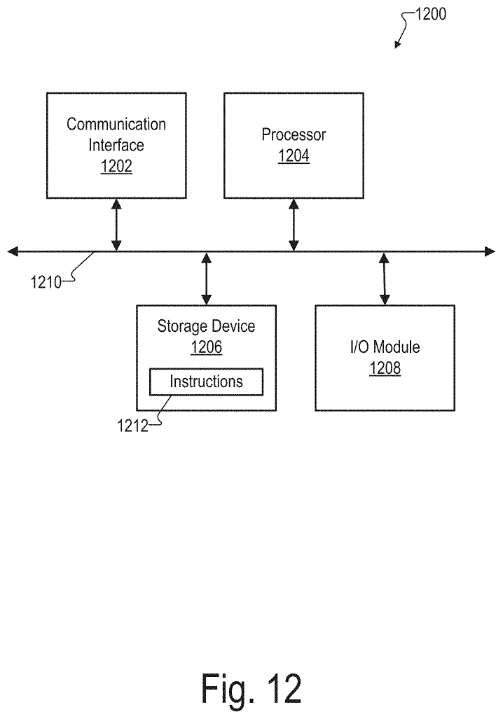

FIG. 12 illustrates an exemplary computing device 1200 that may be specifically configured to perform one or more of the processes described herein. As shown in FIG. 12, computing device 1200 may include a communication interface 1202, a processor 1204, a storage device 1206, and an input/output (I/O) module 1208 communicatively connected one to another via a communication infrastructure 1210. While an exemplary computing device 1200 is shown in FIG. 12, the components illustrated in FIG. 12 are not intended to be limiting. Additional or alternative components may be used in other embodiments. Components of computing device 1200 shown in FIG. 12 will now be described in additional detail.

Communication interface 1202 may be configured to communicate with one or more computing devices. Examples of communication interface 1202 include, without limitation, a wired network interface (such as a network interface card), a wireless network interface (such as a wireless network interface card), a modem, an audio/video connection, and any other suitable interface.

Processor 1204 generally represents any type or form of processing unit capable of processing data and/or interpreting, executing, and/or directing execution of one or more of the instructions, processes, and/or operations described herein. Processor 1204 may perform operations by executing computer-executable instructions 1212 (e.g., an application, software, code, and/or other executable data instance) stored in storage device 1206.

Storage device 1206 may include one or more data storage media, devices, or configurations and may employ any type, form, and combination of data storage media and/or device. For example, storage device 1206 may include, but is not limited to, any combination of the non-volatile media and/or volatile media described herein. Electronic data, including data described herein, may be temporarily and/or permanently stored in storage device 1206. For example, data representative of computer-executable instructions 1212 configured to direct processor 1204 to perform any of the operations described herein may be stored within storage device 1206. In some examples, data may be arranged in one or more databases residing within storage device 1206.

I/O module 1208 may include one or more VO modules configured to receive user input and provide user output. One or more I/O modules may be used to receive input for a virtual experience. I/O module 1208 may include any hardware, firmware, software, or combination thereof supportive of input and output capabilities. For example, I/O module 1208 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1208 is configured to provide graphical data to a display for presentation to a user. The graphical data may be representative of one or more graphical user interfaces and/or any other graphical content as may serve a particular implementation.

In some examples, any of the systems, computing devices, and/or other components described herein may be implemented by computing device 1200. For example, memory 102 may be implemented by storage device 1206, and processor 104 may be implemented by processor 1204.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
assigning, by a resource distribution system, a semi-fungible digital asset to a plurality of resources, the semi-fungible digital asset including a resource counter;
setting, by the resource distribution system, a value of the resource counter based on a number of resources in the plurality of resources;
detecting, by the resource distribution system, a distribution event associated with the plurality of resources; and
adjusting, by the resource distribution system, the value of the resource counter based on the distribution event.

2. The method of claim 1, further comprising generating, by the resource distribution system, the semi-fungible digital asset that includes the resource counter.

3. The method of claim 1, wherein the value of the resource counter equals the number of resources in the plurality of resources.

4. The method of claim 1, wherein the distribution event comprises a consumption of a resource included in the plurality of resources.

5. The method of claim 4, wherein the adjusting of the value of the resource counter includes decreasing the value of the resource counter of the semi-fungible digital asset based on the consumption of the resource.

6. The method of claim 5, further comprising:
detecting, by the resource distribution system, an additional distribution event comprising an additional consumption of an additional resource included in the plurality of resources; and
further adjusting the value of the resource counter based on the additional consumption of the additional resource.

7. The method of claim 4, wherein:
the resource includes access authorization to access at least one of digital content or a service; and
the consumption of the resource includes a user using the access authorization to access the at least one of the digital content or the service.

8. The method of claim 4, wherein:
the resource includes a physically consumable resource; and
the consumption includes a physical consumption of the physical consumable resource.

9. The method of claim 1, wherein:
the semi-fungible digital asset is a parent semi-fungible digital asset;
the distribution event includes separating resources out of the plurality of resources into a plurality of child resource units, each child resource unit included in the plurality of child resource units including one or more resources from the plurality of resources;
the method further comprises assigning, by the resource distribution system and from the parent semi-fungible digital asset, a child semi-fungible digital asset to each child resource unit included in the plurality of child resource units, each child semi-fungible digital asset including an additional resource counter;
the adjusting of the value of the resource counter includes decreasing the value of the resource counter of the parent semi-fungible digital asset based on the separating of the resources out of the plurality of resources into the plurality of child resource units.

10. The method of claim 9, further comprising:
setting, by the resource distribution system, a value of each additional resource counter based on a number of resources included in each child resource unit included in the plurality of child resource units;
detecting, by the resource distribution system, an additional distribution event associated with a child resource unit included in the plurality of child resource units; and
adjusting, by the resource distribution system, the value of the additional resource counter of the child resource unit based on the additional distribution event.

11. The method of claim 10, wherein the additional distribution event corresponds to a consumption of a child resource included in the child resource unit.

12. A method comprising:
detecting, by a resource distribution system, a distribution event associated with a resource included in a plurality of resources, the plurality of resources associated with a semi-fungible digital asset that defines a resource counter that identifies a number of resources in the plurality of resources;
adjusting, by the resource distribution system and based on the detecting of the distribution event, a value of the resource counter defined by the semi-fungible digital asset; and
recording, by the resource distribution system and in a distributed record that is configured to track distribution of the plurality resources, information associated with the adjustment of the value of the resource counter.

13. The method of claim 12, wherein:
the semi-fungible digital asset further defines an additional resource counter that identifies a number of additional resources included in a plurality of additional resources; and
the method further comprises:
detecting, by the resource distribution system, an additional distribution event associated with an additional resource included in a plurality of additional resources;
adjusting, by the resource distribution system and based on the detecting of the additional distribution event, a value of the additional resource counter defined by the semi-fungible digital asset; and
recording, by the resource distribution system and in the distributed record, information associated with the adjustment of the value of the additional resource counter.

14. The method of claim 12, further comprising:
determining, by the resource distribution system and after adjusting the value of the resource counter, that the value of the resource counter is zero; and
increasing, by the resource distribution system, the value of the resource counter to a value greater than zero.

15. The method of claim 12, wherein:
the semi-fungible digital asset corresponds to a parent semi-fungible digital asset;
the distribution event includes separating resources out of the plurality of resources into a plurality of child resource units, each child resource unit included in the plurality of child resource units including one or more resources from the plurality of resources;
the method further comprises assigning, by the resource distribution system and from the parent semi-fungible digital asset, a child semi-fungible digital asset to each child resource unit included in the plurality of child resource units, each child semi-fungible digital asset including an additional resource counter;
the adjusting of the value of the resource counter includes decreasing the value of the resource counter of the parent semi-fungible digital asset based on the separating of the resources out of the plurality of resources into the plurality of child resource units.

16. The method of claim 15, further comprising:
setting, by the resource distribution system, a value of each additional resource counter based on a number of resources included in each child resource unit included in the plurality of child resource units;
detecting, by the resource distribution system, an additional distribution event associated with a child resource unit included in the plurality of child resource units; and
adjusting, by the resource distribution system, the value of the additional resource counter of the child resource unit based on the additional distribution event.

17. The method of claim 16, wherein the additional distribution event corresponds to a consumption of a child resource included in the child resource unit.

18. The method of claim 17, further comprising recording, by the resource distribution system in the distributed record, additional information associated with the consumption of the child resource included in the child resource unit.

19. A system comprising:
a memory that stores instructions; and
a processor communicatively coupled to the memory and configured to execute the instructions to:
detect a distribution event associated with a resource included in a plurality of resources, the plurality of resources associated with a semi-fungible digital asset that defines a resource counter that identifies a number of resources in the plurality of resources;
adjust, based on the detecting of the distribution event, a value of the resource counter defined by the semi-fungible digital asset; and
record, in a distributed record that is configured to track distribution of the plurality resources, information associated with the adjustment of the value of the resource counter.

20. The system of claim 19, wherein the processor is further configured to execute the instructions to:
detect an additional distribution event associated with the resource included in the plurality of resources;
further adjust, based on the detecting of the additional distribution event, the value of the resource counter; and
record, in the distributed record, updated information associated with the further adjustment of the value of the resource counter.
